(19) United States
(12) Patent Application Publication
(10) Pub. No.: US 2026/0348399 A1
(43) Pub. Date: Nov. 5, 2026

(54) FAN DEVICE, WEARABLE DEVICE, AND PROGRAM FOR DRIVING FAN

(71) Applicant: Sony Interactive Entertainment Inc., Tokyo (JP)

(72) Inventors: Chenghui Liu, Tokyo (JP); Youngbo Shim, Tokyo (JP)

(73) Assignee: Sony Interactive Entertainment Inc., Tokyo (JP)

(21) Appl. No.: 19/713,478

(22) Filed: Jun. 18, 2026

Related U.S. Application Data
(63) Continuation of application No. PCT/JP2023/045625, filed on Dec. 20, 2023.

(51) Int. Cl. F04D 29/60; F04D 25/08; G02B 27/01

(52) U.S. Cl. CPC F04D 29/601; F04D 25/08; G02B 27/0176

(57) ABSTRACT

A fan device and a fan device control method are disclosed. An example fan device is to be attached to a wearable device that is to be worn on a head of a user. The fan device includes fans for supplying wind to a front of a face of the user, a fan for supplying wind to a left side of the face of the user, and a fan for supplying wind to a right side of the face of the user.

### CROSS-REFERENCES TO RELATED APPLICATIONS

This application is a continuation of international patent application No. PCT/JP2023/045625, filed Dec. 20, 2023, which is hereby incorporated by reference in its entirety for all purposes.

### BACKGROUND

The present disclosure relates to a technology for supplying wind to a user wearing a wearable device on his/her head.

For example, JP 2018-126341 A discloses a simulation game system that causes a blower, which is disposed on a movable housing boarded by a user, to supply air to a supply target existing in a real space while maintaining a relative positional relation between the blower and the user.

### SUMMARY

A head mounted display (HMD) attached to the head of a user provides a video world expressing virtual reality (VR) for the user. The user wearing the HMD operates a game controller to give various types of input to a video space offered by a game. The HMD provides VR images throughout the visual field of the user, thereby enhancing a sense of immersion of the user in the video world. The present discloser has paid attention to potentiality of wearable devices such as HMDs and smart glasses, and has investigated development of a technology for further enhancing VR and augmented reality (AR) experienced by users.

An object of the present disclosure is to provide a technology which supplies wind to a user wearing a wearable device such as an HMD to enhance VR and AR experienced by the user, for example.

An aspect of the present disclosure is directed to a fan device to be attached to a wearable device that is to be attached to a head of a user, the fan device including a first fan unit that has a fan for supplying wind to a front of a face of the user, a second fan unit that has a fan for supplying wind to a left side of the face of the user, and a third fan unit that has a fan for supplying wind to a right side of the face of the user.

Another aspect of the present invention is directed to a wearable device to be attached to a head of a user, the wearable device including a first fan unit that has a fan for supplying wind to a front of a face of the user, a second fan unit that has a fan for supplying wind to a left side of the face of the user, and a third fan unit that has a fan for supplying wind to a right side of the face of the user.

A further aspect of the present disclosure is directed to a program to be executed by a computer of an information processing device, the program causing the computer to implement a function of controlling a movement of a player character according to operation input from a user, a function of determining a wind direction at a position of the player character within a virtual space, a function of generating control signals for individually driving each of at least three fans attached to a wearable device based on the determined wind direction, and a function of transmitting the control signals.

Note that any combinations of constituent elements described above and expressions of the present disclosure converted into those of methods, devices, systems, computer programs, recording media where computer programs are readably recorded, data structures, and the like are also effective as modes of the present disclosure.

### BRIEF DESCRIPTION OF THE DRAWINGS

FIG. 1 is a diagram illustrating a configuration example of an information processing system according to an embodiment.

FIG. 2 is a diagram illustrating an example of an external shape of an HMD.

FIG. 3 is a diagram illustrating function blocks of the HMD.

FIG. 4 is a diagram illustrating function blocks of an information processing device.

FIG. 5 is a diagram illustrating an example of a route in a cave of a game.

FIG. 6 is a diagram illustrating an example of a game image displayed on a display panel.

FIG. 7 is a diagram illustrating an example of a fan device attached to the HMD.

FIG. 8 is a diagram illustrating another example of the fan device attached to the HMD.

FIG. 9 is a diagram illustrating a further example of the fan device attached to the HMD.

FIG. 10 is a diagram illustrating a still further example of the fan device attached to the HMD.

FIG. 11 is a diagram illustrating a still further example of the fan device attached to the HMD.

FIG. 12 is a diagram illustrating a state where the fan device is attached to the HMD via a fixture.

FIG. 13 is a diagram illustrating function blocks of a fan unit.

FIG. 14 is a diagram illustrating an example of a plurality of partial spaces.

FIG. 15 is a diagram illustrating an example of wind parameters set for a partial space.

FIG. 16 is a diagram illustrating a wind direction determined at a position of a player character.

FIG. 17 is a diagram of a three-dimensional expression of a partial space.

FIG. 18 is a diagram illustrating an example of wind parameters set for a partial space.

FIG. 19 is a diagram illustrating a wind direction determined at a position of a player character.

FIG. 20 is a diagram illustrating a relative angle formed by a visual line direction of a player character and a wind direction.

### DETAILED DESCRIPTION

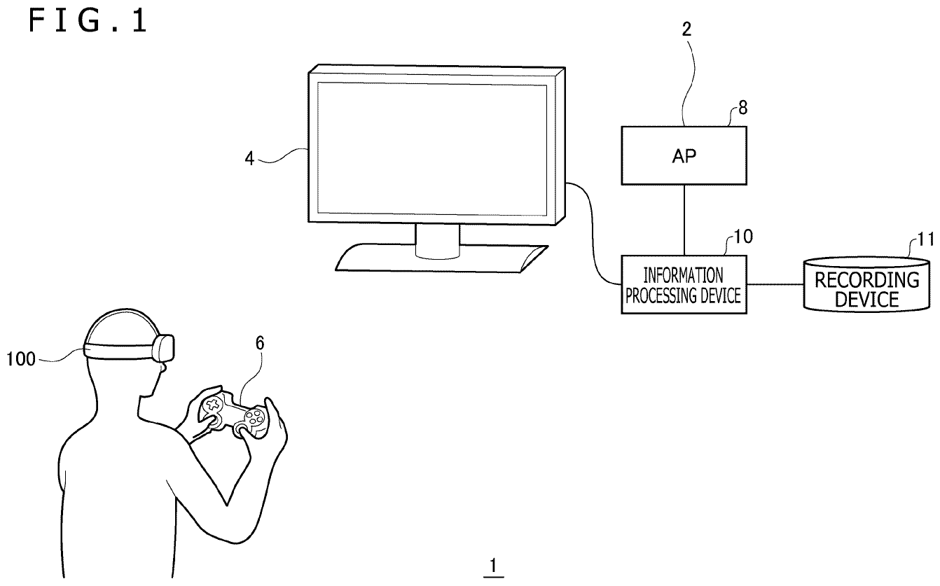

FIG. 1 illustrates a configuration example of an information processing system 1 according to an embodiment. The information processing system 1 is a game system which includes an information processing device 10 for running a game, an HMD 100 attached to the head of a user, an input device 6 held by the user and operated by the fingers, a recording device 11, and an output device 4 for outputting images and sounds. The output device 4 may be constituted by a television set. According to the embodiment, the HMD 100 is an example of a wearable device attached to the head of the user. The information processing system 1 may include VR goggles, AR glasses, or smart glasses as the wearable device. The information processing device 10 is connected to an external network 2, such as the Internet, via an access point (AP) 8.

The recording device 11 records applications such as game software. The information processing device 10 may download game software to the recording device 11 from a content server (not illustrated) via the network 2. The information processing device 10 runs game software (hereinafter also simply referred to as a “game”) according to operation input received from the user to generate image data and audio data of the game, and supplies the generated data to the HMD 100. The information processing device 10 and the HMD 100 may be connected to each other by a known wireless communication protocol, or by a cable.

The HMD 100 is a display device attached to the head of the user to display images on a display panel located before the eyes of the user. The HMD 100 individually displays an image for the left eye on a left-eye display panel and an image for the right eye on a right-eye display panel. These images constitute parallax images viewed from left and right viewpoints to provide a stereoscopic vision. The user views the display panel through an optical lens. Accordingly, the information processing device 10 supplies to the HMD 100 parallax image data corrected to cancel optical distortion produced by the lens.

The output device 4 is unnecessary for the user wearing the HMD 100. However, if the output device 4 is prepared, other users are allowed to view images displayed on the output device 4. The information processing device 10 may display on the output device 4 the same images as the images viewed by the user wearing the HMD 100, or may display other images thereon. For example, in a case where the user wearing the HMD 100 plays a game with a different user, game images from a viewpoint of a character of this different user may be displayed on the output device 4.

The information processing device 10 and the input device 6 may be connected to each other by a known wireless communication protocol, or by a cable. The input device 6 includes a plurality of operation members, such as operation buttons and analog sticks. The user operates these operation members with the fingers while holding the input device 6. While the information processing device 10 is running the game, the input device 6 is handled as a game controller.

In the game played in the embodiment, information (operation input) associated with operations input to the operation members of the input device 6 from the user is reflected in movements of a player character existing in a virtual three-dimensional space. During the game, operations input to the left analog stick may be linked to processes for shifting the player character, while operations input to the right analog stick may be linked to processes for changing a visual line direction of the player character. In addition, in a case where sensor data measured by an inertial measurement unit (IMU) included in the input device 6 is periodically transmitted to the information processing device 10, the sensor data of the IMU in the game may be handled as operations input to the input device 6, and reflected in movements (shifts, visual line direction changes, etc.) of the player character.

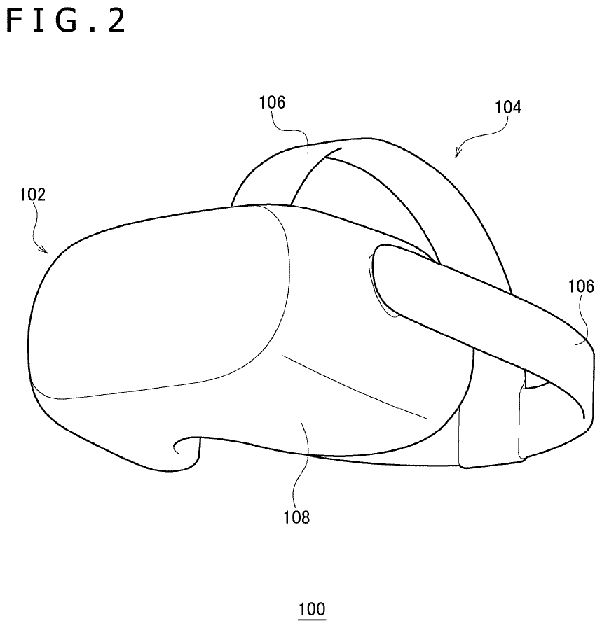

FIG. 2 illustrates an example of an external shape of the HMD 100. The HMD 100 includes an output unit 102 and a fixing unit 104. The fixing unit 104 includes an attachment component 106 which attaches the HMD 100 to the user head when the user wears the HMD 100. The attachment component 106 has a material or a structure having a length adjustable to the circumference of the user head.

The output unit 102 includes a housing 108 shaped to cover the left and right eyes of the user wearing the HMD 100, and contains inside a display panel facing the eyes in the state of attachment. The display panel may be a liquid crystal panel, an organic electro-luminescence (EL) panel, or the like. The housing 108 also contains inside a pair of left and right optical lenses disposed between the display panel and the eyes of the user to expand a viewing angle of the user. The HMD 100 may further include a speaker or an earphone at each of positions corresponding to the ears of the user, and may be also configured to be connectable with an external headphone.

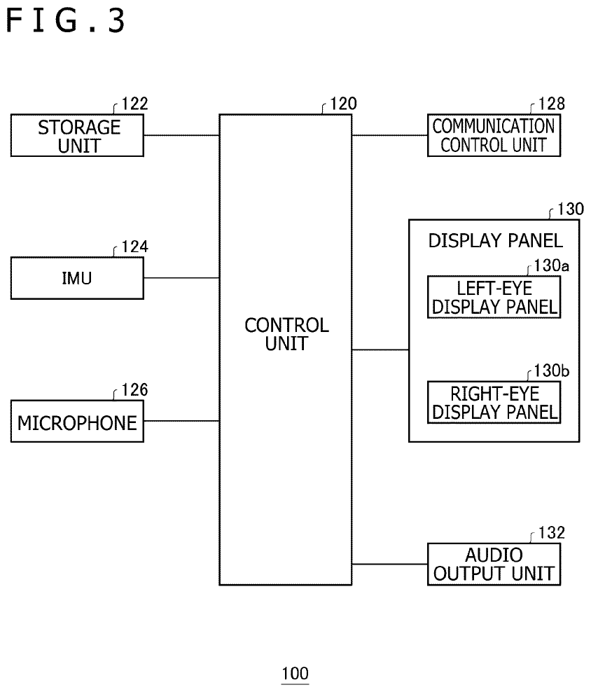

FIG. 3 illustrates function blocks of the HMD 100. A control unit 120 is a main processor which processes and outputs various types of data, such as image data, sound data, and sensor data, and commands. A storage unit 122 temporarily stores data, commands, and the like processed by the control unit 120. An IMU 124 acquires sensor data associated with movements of the HMD 100. The IMU 124 may include at least a triaxial acceleration sensor and a triaxial angular velocity sensor. The IMU 124 periodically detects values of respective axial components (sensor data) in a predetermined cycle (e.g., 800 Hz).

A communication control unit 128 transmits data output from the control unit 120 to the information processing device 10, which is equipped outside, by wired or wireless communication via a network adapter or an antenna. Moreover, the communication control unit 128 receives data from the information processing device 10, and outputs the received data to the control unit 120.

The control unit 120 having received game image data from the information processing device 10 supplies the received data to a display panel 130 and causes the display panel 130 to display images. The control unit 120 having received game sound data from the information processing device 10 supplies the received data to an audio output unit 132 and causes the audio output unit 132 to output sounds. The display panel 130 includes a left-eye display panel 130a and a right-eye display panel 130b, and displays a pair of parallax images on the respective display panels. The control unit 120 causes the communication control unit 128 to transmit sensor data received from the IMU 124 and audio data received from a microphone 126 to the information processing device 10.

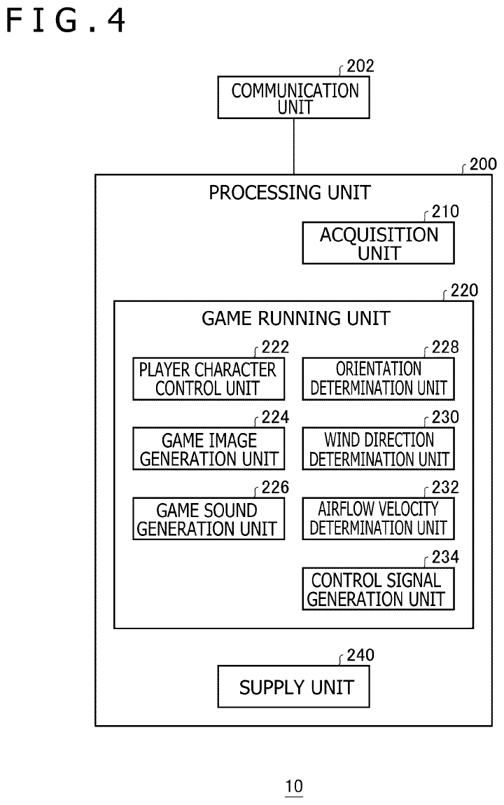

FIG. 4 illustrates function blocks of the information processing device 10. The information processing device 10 includes a processing unit 200 and a communication unit 202. The processing unit 200 includes an acquisition unit 210, a game running unit 220, and a supply unit 240. The game running unit 220 includes a player character control unit 222, a game image generation unit 224, a game sound generation unit 226, an orientation determination unit 228, a wind direction determination unit 230, an airflow velocity determination unit 232, and a control signal generation unit 234. The communication unit 202 receives operation information transmitted from the input device 6 and indicating operation input to operation members, and supplies the operation information to the acquisition unit 210. Moreover, the communication unit 202 receives sensor data transmitted from the HMD 100 and supplies the sensor data to the acquisition unit 210.

Functions of constituent elements equipped on the information processing device 10 may be implemented by circuits (circuitries) or processing circuits (processing circuitries), including general-purpose processors, specific-purpose processors, integrated circuits, application specific integrated circuits (ASICs), a central processing unit (CPU), conventional circuits, and/or combinations thereof, and configured or programmed to implement functions noted in the present specification. Each of the processors is considered as a circuit (circuitry) or a processing circuit (processing circuitry) including a transistor or other circuits. Each of the processors may be a programmed processor configured to run programs stored in a memory.

In the present specification, each of circuits (circuitries), units, and means is hardware programmed to implement the noted functions or carrying out the noted functions. This hardware may be any type of hardware disclosed in the present specification, or any type of hardware programmed to implement the noted functions, or known as hardware implementing the noted functions.

In a case where this hardware is a processor considered as a circuit (circuitry) type, the circuit (circuitry), the means, or the unit may be constituted by a combination of hardware, and software used to constitute the hardware and/or the processor.

The acquisition unit 210 having acquired operation information transmitted from the input device 6 and sensor data transmitted from the HMD 100 supplies the acquired information and data to the game running unit 220 as operation input from the user to the game. According to the embodiment, the game running unit 220 runs a game which requires a player character to escape from an intricate cave like a labyrinth.

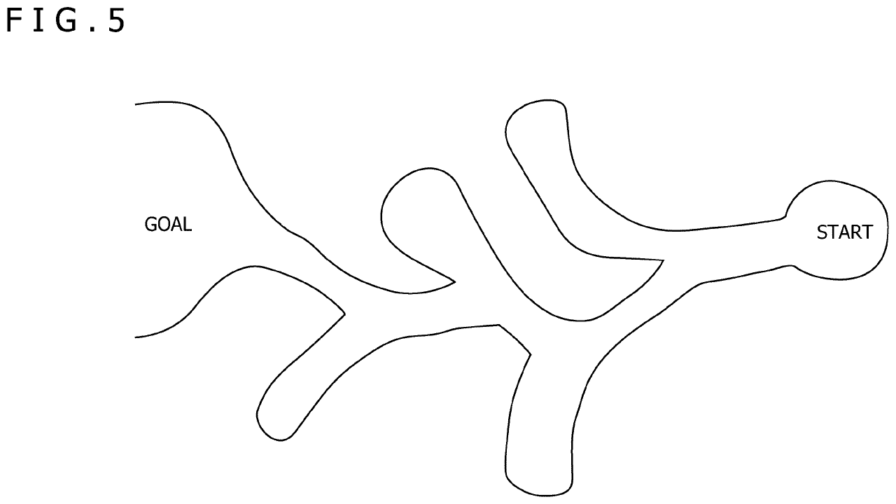

FIG. 5 illustrates an example of a cave route formed in the game. A plurality of route branch points are defined from a start spot to a goal spot. The player character is required to move forward along a correct route for all of the branch points to reach the goal spot.

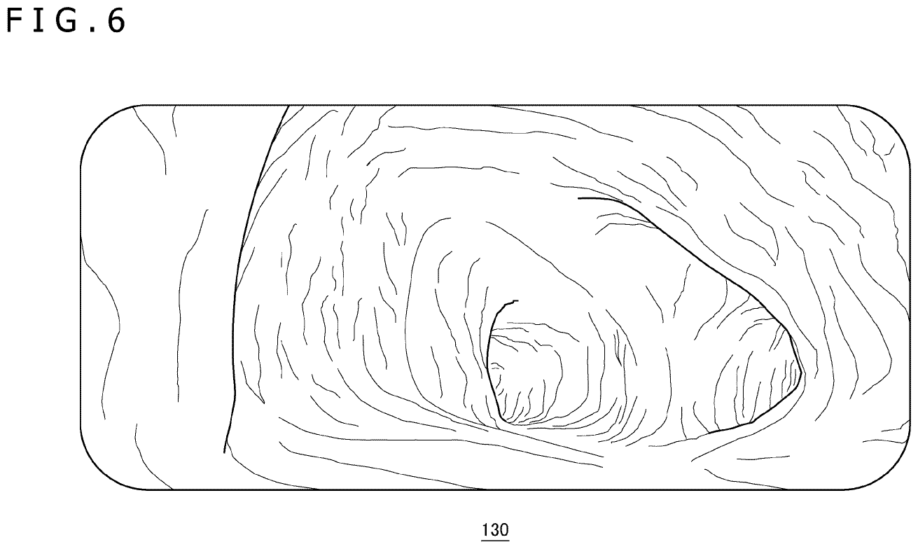

FIG. 6 illustrates an example of a game image displayed on the display panel 130. According to the embodiment, the game running unit 220 runs a game program according to operation input from the user, and performs arithmetic processing to move the player character operated by the user within the cave corresponding to a three-dimensional virtual reality space. The player character control unit 222 controls movements of the player character in the cave, specifically, moves the play character according to operation input to the left analog stick, and determines a visual line direction of the player character according to operation input to the right analog stick.

The game image generation unit 224 includes a graphics processing unit (GPU) for executing rendering and the like, and generates, according to an arithmetic processing result obtained in the virtual reality space, game images captured at a virtual camera position within the virtual reality space. According to this embodiment, the game image generation unit 224 generates game images from a first-person perspective, and generates visibility images of the player character on the basis of the visual line direction determined by the player character control unit 222. According to the embodiment, the game image generation unit 224 generates a pair of parallax images constituted by a left-eye VR image and a right-eye VR image. The game sound generation unit 226 generates game sounds.

The orientation determination unit 228 determines an orientation of the HMD 100 on the basis of sensor data transmitted from the HMD 100 to determine the visual line direction of the user. According to the embodiment, the game image generation unit 224 may use the visual line direction of the user determined by the orientation determination unit 228 as a visual line direction of the player character. Note that the game image generation unit 224 may align the visual line direction of the user with the visual line direction of the player character (virtual camera), or may correct the visual line direction of the user and determine the visual line direction of the player character on the basis of the corrected visual line direction.

The cave escape game herein is a time trial game where players compete for the speed for reaching the goal. If the player character selects an incorrect route at a route branch point, the player advancing along this route comes to a dead end and loses time. During gameplay, the user is given a hint concerning a correct moving direction, and selects a route at each branch point on the basis of this hint.

In a real cave, wind enters the cave through an opening of the cave (note that some wind blows out of the cave through the opening). Accordingly, the cave escape game uses this wind direction as a hint. According to the information processing system 1 of the embodiment, a fan device is attached to the HMD 100 attached to the head of the user to supply wind to the user and offers a hint associated with the direction of the opening of the cave (goal spot). According to the embodiment, the fan device includes at least three fans to supply wind coming in any direction to the user.

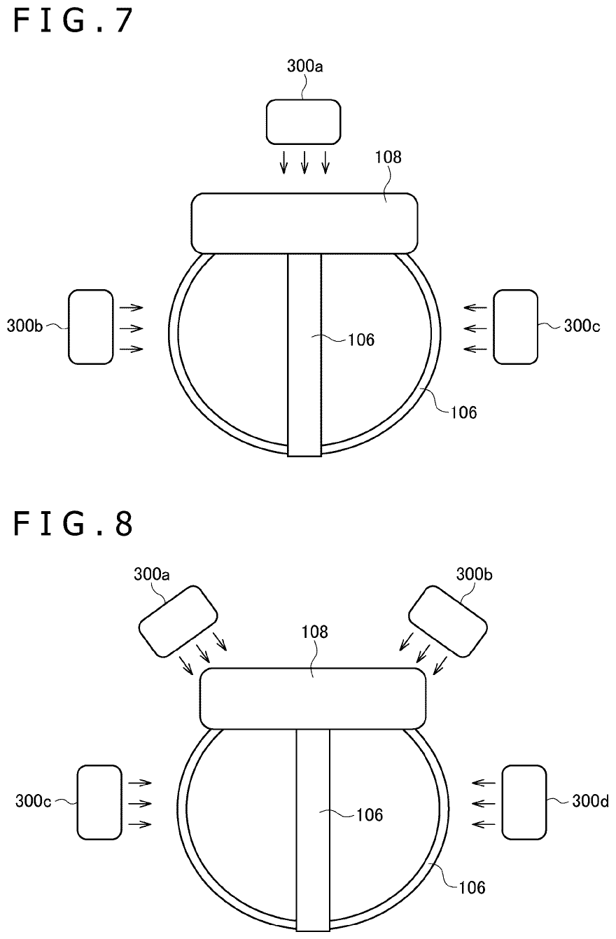

FIG. 7 illustrates an example of the fan device attached to the HMD 100. FIG. 7 is a schematic diagram of the user wearing the HMD 100 and viewed from the head top side. The fan device illustrated in FIG. 7 includes three fans, specifically, a fan 300a for supplying wind to a front of the face of the user, a fan 300b for supplying wind to a left side of the face of the user, and a fan 300c for supplying wind to a right side of the face of the user. In the present specification, the front of the face may be also referred to as a front of the head, the left side of the face may be also referred to as a left side of the head, and the right side of the face may be also referred to as a right side of the head. In FIG. 7, each of arrows given to the fans 300a, 300b, and 300c indicates a wind blowing direction. The fan 300a supplies wind toward the center of the front face of the user. The fan device illustrated in FIG. 7 and including the fans 300a, 300b, and 300c can blow wind to the entire face of the user (excluding the portion covered by the HMD 100) in various directions by adjusting each rotation speed of the fans 300a, 300b, and 300c. Each of the fans included in the fan device will be hereinafter also simply referred to as a “fan 300” in cases where distinction therebetween is not particularly needed.

It is preferable that each of the plurality of fans 300 is disposed below the components of the HMD 100. Specifically, the fan 300a is disposed below the housing 108, while the fans 300b and 300c are disposed below the attachment component 106 provided for fixation to the head. This arrangement of the fans 300 located below the components of the HMD 100 enables the fans 300 to efficiently supply wind to the user without interruption by the components.

An orientation of the fans 300 is determined such that directions of wind are toward the face (or the head) of the user. For example, the fans 300 may be disposed such that the wind blowing directions (blowing out directions) are aligned with directions toward the head center axis. Each of the fans 300 may be an axial flow fan which has a propeller fan and discharges air in the axial direction during forward rotation. Moreover, each of the fans 300 may be of a type capable of discharging air in the axial direction during forward rotation, and sucking air in the axial direction during backward rotation. Various types of fans may be adopted as the fans 300. However, for convenience of attachment to the HMD 100, it is preferable that the fans 300 are small-sized and lightweight fans.

FIG. 8 illustrates another example of the fan device attached to the HMD 100. FIG. 8 is a schematic diagram of the user wearing the HMD 100 and viewed from the head top side. The fan device illustrated in FIG. 8 includes four fans, specifically, the fan 300a for supplying wind to a front of the face of the user, the fan 300b for supplying wind to a front of the face of the user, the fan 300c for supplying wind to a left side of the face of the user, and a fan 300d for supplying wind to a right side of the face of the user. The fan 300a illustrated in FIG. 8 primarily supplies wind to the left front side of the face of the user, while the fan 300b primarily supplies wind to the right front side of the face of the user. The fan device illustrated in FIG. 8 and including the fans 300a, 300b, 300c, and 300d can blow wind to the entire face of the user (excluding the portion covered by the HMD 100) in various directions by adjusting each rotation speed of the fans 300a, 300b, 300c, and 300d.

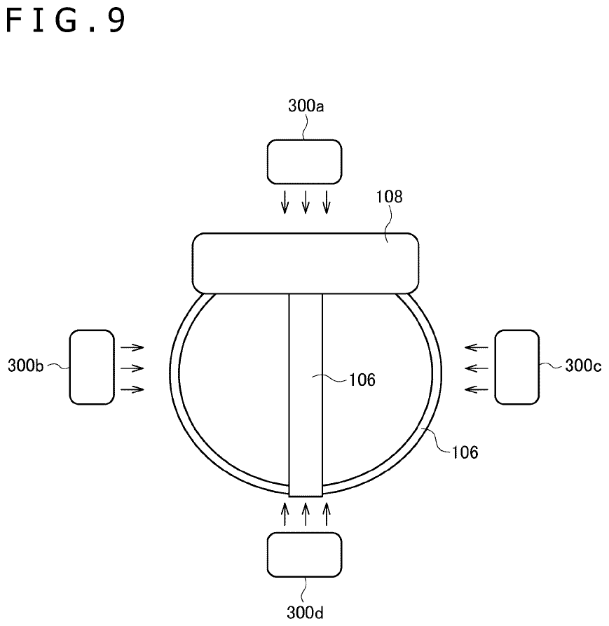

FIG. 9 illustrates a further example of the fan device attached to the HMD 100. FIG. 9 is a schematic diagram of the user wearing the HMD 100 and viewed from the head top side. The fan device illustrated in FIG. 9 includes four fans, specifically, the fan 300a for supplying wind to a front of the face of the user, the fan 300b for supplying wind to a left side of the face of the user, the fan 300c for supplying wind to a right side of the face of the user, and the fan 300d for supplying wind to a back surface of the head or a back surface of the neck of the user. The fan 300d illustrated in FIG. 9 supplies wind toward the center of the back of the head or the neck of the user. The fan device illustrated in FIG. 9 and including the fans 300a, 300b, 300c, and 300d can blow wind to the entire face of the user (excluding the portion covered by the HMD 100) and the back surface of the head or the neck of the user in various directions by adjusting each rotation speed of the fans 300a, 300b, 300c, and 300d.

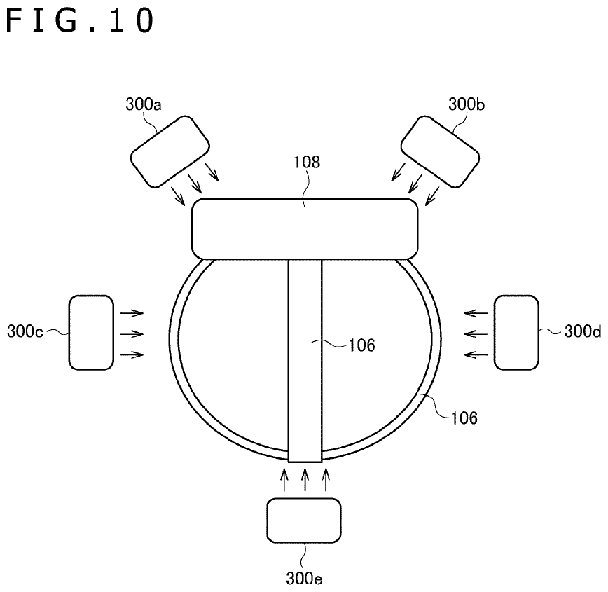

FIG. 10 illustrates a still further example of the fan device attached to the HMD 100. FIG. 10 is a schematic diagram of the user wearing the HMD 100 and viewed from the head top side. The fan device illustrated in FIG. 10 includes five fans, specifically, the fan 300a for supplying wind to a front of the face of the user, the fan 300b for supplying wind to a front of the face of the user, the fan 300c for supplying wind to a left side of the face of the user, the fan 300d for supplying wind to a right side of the face of the user, and a fan 300e for supplying wind to a back surface of the head or a back surface of the neck of the user. The fan 300a illustrated in FIG. 10 primarily supplies wind to the left front side of the face of the user, while the fan 300b primarily supplies wind to the right front side of the face of the user. The fan device illustrated in FIG. 10 and including the fans 300a, 300b, 300c, 300d, and 300e can blow wind to the entire face of the user (excluding the portion covered by the HMD 100) and the back surface of the head or the neck of the user in various directions by adjusting each rotation speed of the fans 300a, 300b, 300c, 300d, and 300e.

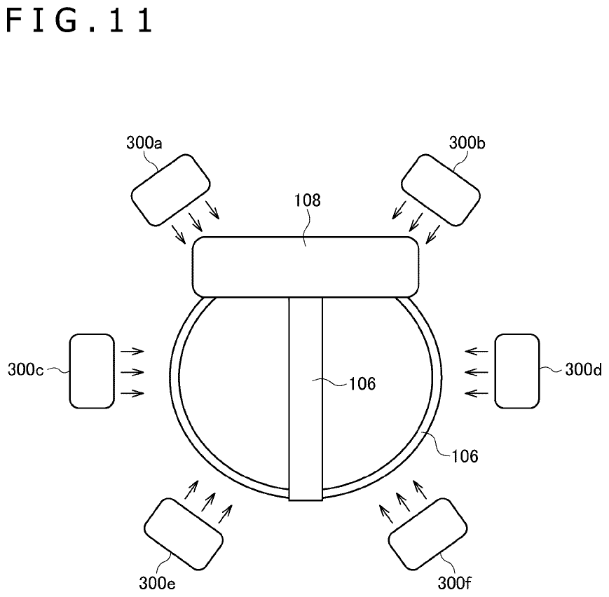

FIG. 11 illustrates a still further example of the fan device attached to the HMD 100. FIG. 11 is a schematic diagram of the user wearing the HMD 100 and viewed from the head top side. The fan device illustrated in FIG. 11 includes six fans, specifically, the fan 300a for supplying wind to a front of the face of the user, the fan 300b for supplying wind to a front of the face of the user, the fan 300c for supplying wind to a left side of the face of the user, a fan 300d for supplying wind to a right side of the face of the user, the fan 300e for supplying wind to a back surface of the head or a back surface of the neck of the user, and a fan 300f for supplying wind to a back surface of the head or a back surface of the neck of the user. The fan 300a illustrated in FIG. 11 primarily supplies wind to the left front side of the face of the user, the fan 300b primarily supplies wind to the right front side of the face of the user, the fan 300e primarily supplies wind to the back left side of the head or the neck of the user, and the fan 300f primarily supplies wind to the back right side of the head or the neck of the user. The fan device illustrated in FIG. 11 and including the fans 300a, 300b, 300c, 300d, 300e, and 300f can blow wind to the entire face of the user (excluding the portion covered by the HMD 100) and the back surface of the head or the neck of the user in various directions by adjusting each rotation speed of the fans 300a, 300b, 300c, 300d, 300e, and 300f.

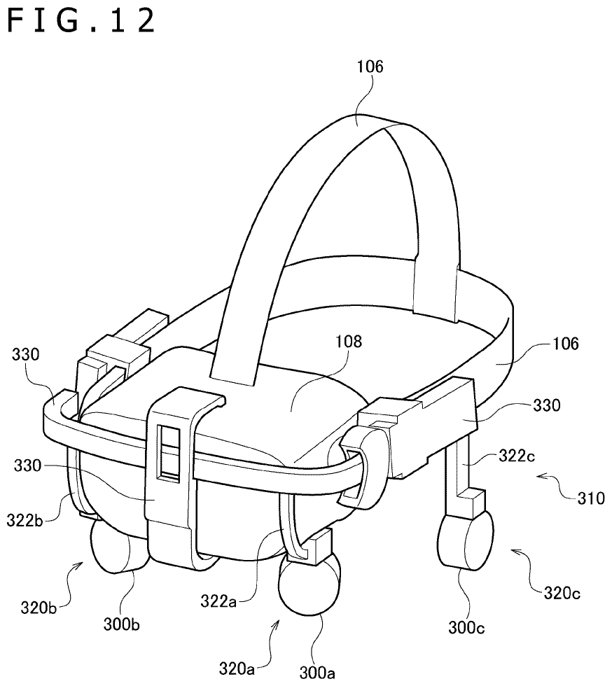

FIG. 12 illustrates a state of a fan device 310 attached to the HMD 100 via a fixture 330. According to the embodiment, the fan device 310 includes at least three fan units each having the fan 300 for supplying wind to the user. The fan device 310 illustrated in FIG. 12 has the fan arrangement illustrated in FIG. 8, and therefore includes a fan unit 320a which has the fan 300a for supplying wind to the left front side of the face of the user, a fan unit 320b which has the fan 300b for supplying wind to the right front side of the face of the user, a fan unit 320c which has the fan 300c for supplying wind to the left side of the face of the user, and a fan unit 320d (not illustrated) which has the fan 300d for supplying wind to the right side of the face of the user. The fan units 320a, 320b, 320c, and 320d include coupling portions 322a, 322b, 322c, and 322d (not illustrated), respectively, each coupled with and supported by the fixture 330. Hereinafter, the plurality of fan units 320a to 320d will be also simply referred to as “fan units 320” in cases where distinction therebetween is not particularly needed. In addition, the coupling portions 322a to 322d will be also simply referred to as “coupling portions 322” in cases where distinction therebetween is not particularly needed. Note that the fan device 310 illustrated in FIG. 12 is a device presented only by way of example. The fans supplying wind to the front of the face of the user may be constituted by a single fan as illustrated in FIG. 7, and fans for supplying wind to the back of the head or the neck of the user may be separately provided as illustrated in FIGS. 9 to 11.

The fixture 330 is a component for fitting the fan device 310 to the HMD 100 and includes a plurality of parts. The parts of the fixture 330 are attached to the housing 108 having high rigidity, and the attachment component 106 for fixation to the head circumference. The fixture 330 has a structure for supporting the coupling portions 322 of the fan units 320. The coupling portions 322 are supported by the fixture 330. In a case where the HMD 100 has various functions such as a tracking function, it is preferable that the fixture 330 is attached to the HMD 100 in such a manner as not to interrupt the respective functions of the HMD 100, and that the fan units 320 are supported by the fixture 330 in such a manner as not to interrupt the respective functions of the HMD 100.

According to this embodiment, the fixture 330 supports the fan unit 320a at such a position that the fan 300a faces the left front side of the face of the user, supports the fan unit 320b at such a position that the fan 300b faces the right front side of the face of the user, supports the fan unit 320c at such a position that the fan 300c faces the left side of the face of the user, and supports the fan unit 320d (not illustrated) at such a position that the fan 300d faces the right side of the face of the user. As illustrated in the figure, the fan units 320a and 320b are attached to the housing 108 indirectly with the fixture 330 interposed between the housing 108 and the fan units 320a and 320b, while the fan units 320c and 320d are attached to the attachment component 106 indirectly with the fixture 330 interposed between the attachment component 106 and the fan units 320c and 320d. Note that the coupling portions 322 may be directly supported by the HMD 100 without using the fixture 330 in a case where the HMD 100 has a structure for supporting the coupling portions 322. In addition, the fan units 320 may be attached to the HMD 100 using clips provided at ends of the coupling portions 322.

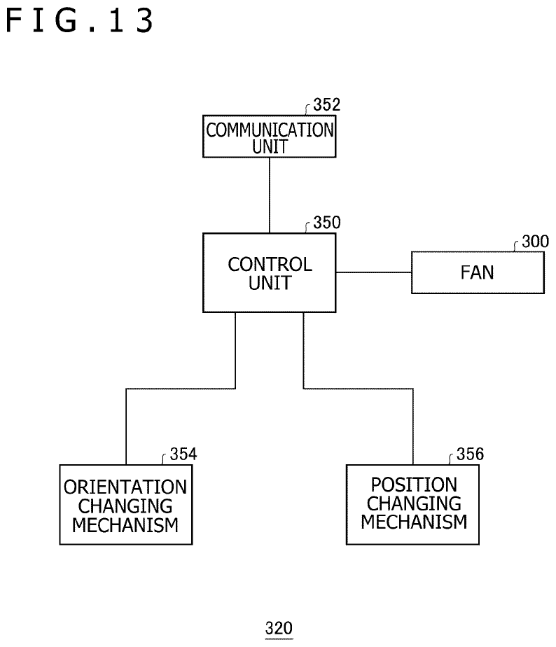

FIG. 13 illustrates function blocks of the fan unit. The fan unit 320 includes the fan 300, a control unit 350, a communication unit 352, an orientation changing mechanism 354, and a position changing mechanism 356. The orientation changing mechanism 354 is a mechanism for changing an orientation of the fan 300, and has a servomotor, for example, to fulfill a function of adjusting the orientation of the fan 300 to a desired orientation. The position changing mechanism 356 is a mechanism for changing spacing between the fan 300 and the user, and has a rack-and-pinion, for example, to fulfill a function of moving the fan 300 closer to or away from the user. The communication unit 352 receives, from the information processing device 10, control signals for driving the fan unit 320. The communication unit 352 may be connected with the communication unit 202 of the information processing device 10 via a cable, or preferably by a known wireless communication protocol. The wireless connection between the fan unit 320 and the information processing device 10 can eliminate complicated routing of the cable and therefore can enhance usability. The control unit 350 drives the fan 300, the orientation changing mechanism 354, and/or the position changing mechanism 356 according to control signals received from the information processing device 10. The information processing device 10 generates control signals according to the status of the game and transmits the generated control signals to the fan unit 320.

Note that all of the plurality of fan units 320 constituting the fan device 310 are not required to have the orientation changing mechanism 354 and/or the position changing mechanism 356, and at least one of the fan units 320 may have the orientation changing mechanism 354 and/or the position changing mechanism 356. In a case where the fan arrangement illustrated in FIG. 7 is adopted, for example, the fan unit 320 including the fan 300a may have the orientation changing mechanism 354, and the fan unit 320 including the fan 300b or 300c may have the position changing mechanism 356. In this case, the fan unit 320 including the fan 300b or 300c may further have the orientation changing mechanism 354. The orientation changing mechanism 354 and/or the position changing mechanism 356 may be incorporated in the fan unit 320 as necessary for a purpose of increasing variations of wind supplied to the user.

Returning to FIG. 4, the player character control unit 222 controls movements of the player character in the three-dimensional virtual space according to operation input from the user. The wind direction determination unit 230 determines the wind direction at the position of the player character in the virtual space. Specifically, the wind direction determination unit 230 has a function of determining the wind direction at the position of the player character on the basis of information indicating wind directions set at at least two positions in the virtual space.

According to the embodiment, the cave corresponding to the virtual space in the game is divided into a plurality of partial spaces. Note that all areas in the cave are not required to be divided into partial spaces, and at least areas constituting the route from the start to the goal may be divided into partial spaces. According to the embodiment, the partial spaces are areas defined for a purpose of supplying wind to the user. While the player character is moving in the partial spaces, the user estimates a correct moving direction of the player character on the basis of wind supplied to the user from the fan device 310 and indicating the correct moving direction.

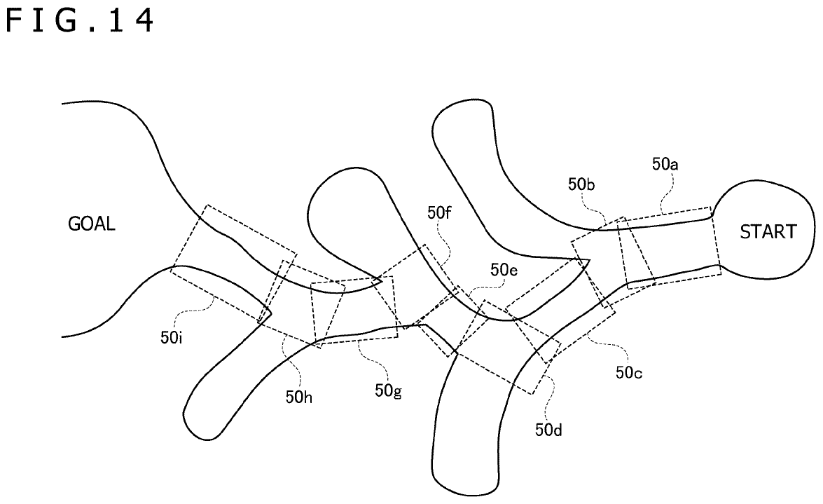

FIG. 14 illustrates an example of a plurality of the partial spaces. According to this embodiment, the route from the start to the goal is divided into a plurality of partial spaces 50a to 50i (hereinafter referred to as “partial spaces 50” in cases where distinction therebetween is not particularly needed). No partial space is defined for routes leading to dead ends in this embodiment. However, partial spaces may be set also for routes leading to dead ends in a modification.

Each of the partial spaces 50 may have a cuboidal shape designed to contain the cave having a three-dimensional shape. Each adjoining pair of the partial spaces 50 may have an overlapping area. The plurality of partial spaces 50 cover the cave areas from the start to the goal. Each of the partial spaces 50 is given a wind parameter for defining the wind direction within the corresponding partial space 50. The wind parameter includes information indicating wind directions set at at least two positions in the partial space 50. The wind direction determination unit 230 determines the wind direction at the position of the player character by calculating a wind direction interpolated between the wind directions set at least the two positions in the partial space 50 on the basis of information indicating the wind directions at these two positions. The wind parameter of the partial space 50 may be set for each of an entrance and an exit of the partial space 50.

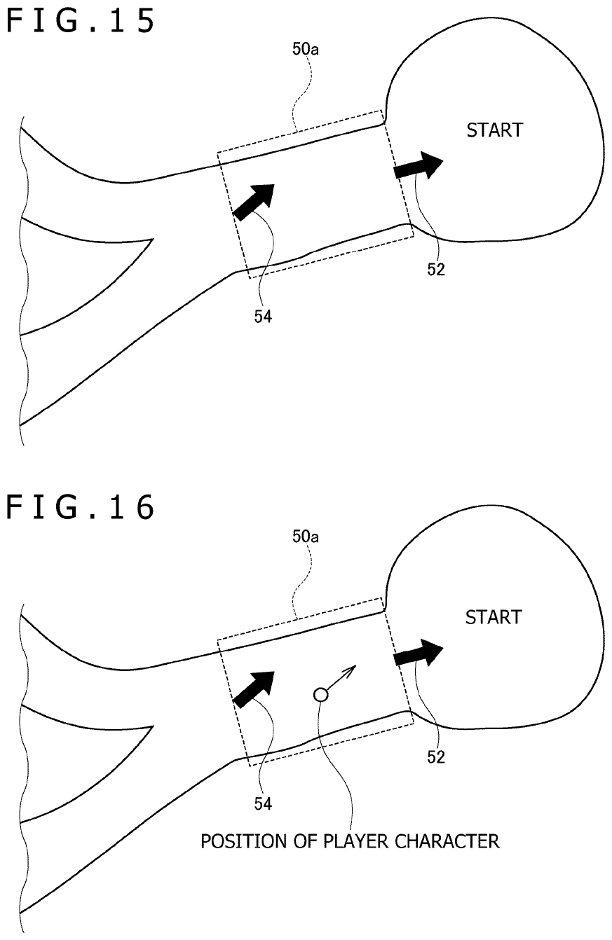

FIG. 15 illustrates an example of wind parameters set for a partial space 50a. A wind parameter 52 indicating a wind direction at an entrance is set for an entrance of the partial space 50a, while a wind parameter 54 indicating a wind direction at an exit is set for an exit of the partial space 50a. Note that two-dimensional wind directions are indicated by directions of arrows to express the wind parameters 52 and 54 in FIG. 15. However, considering that the actual partial space 50a has a three-dimensional cuboidal shape, three-dimensional wind directions may be expressed by the wind parameters 52 and 54.

When the player character exists within the partial space 50a, the wind direction determination unit 230 determines the wind direction at the position of the player character within the partial space 50a on the basis of the wind parameters 52 and 54 in the partial space 50a. Specifically, the wind direction determination unit 230 has a function of calculating a wind direction interpolated at any position between the entrance and the exit of the partial space 50a on the basis of the wind directions indicated by the wind parameters 52 and 54. The wind direction determination unit 230 having acquired the position of the player character in the partial space 50a from the player character control unit 222 may determine the wind direction at this position by interpolation on the basis of the wind direction at the entrance and the wind direction at the exit in the partial space 50a.

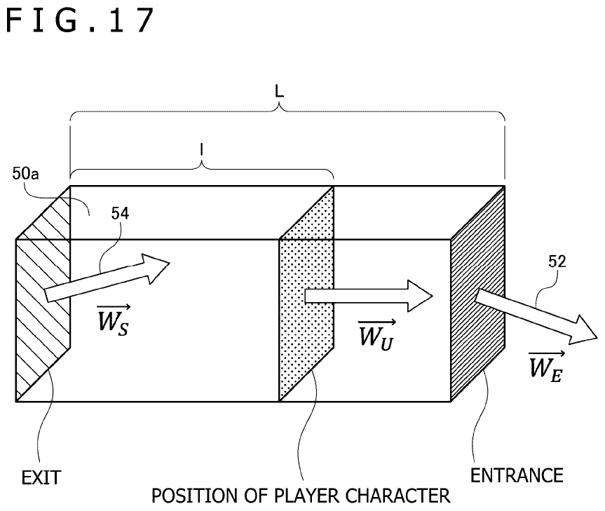

FIG. 16 illustrates the wind direction determined at the position of the player character.

FIG. 17 is a diagram of a three-dimensional expression of the partial space 50a. The wind direction determination unit 230 determines the wind direction at the position of the player character on the basis of the wind parameter 52 at the entrance and the wind parameter 54 at the exit in the partial space 50a. The wind parameters 52 and 54 in the partial space 50a are set for opposite faces of a cuboid. Assuming herein that the wind parameter 52, the wind parameter 54, the distance between the entrance and the exit of the partial space 50a, and the distance between the position of the player character and the exit are WE, WS, L, and I, respectively, the wind direction at the position of the player character may be expressed using following equation (1).

\vec{W}_{U}=\vec{W}_{S}+(\vec{W}_{E}−\vec{W}_{S})×t (1)

In this equation, t equals I/L.

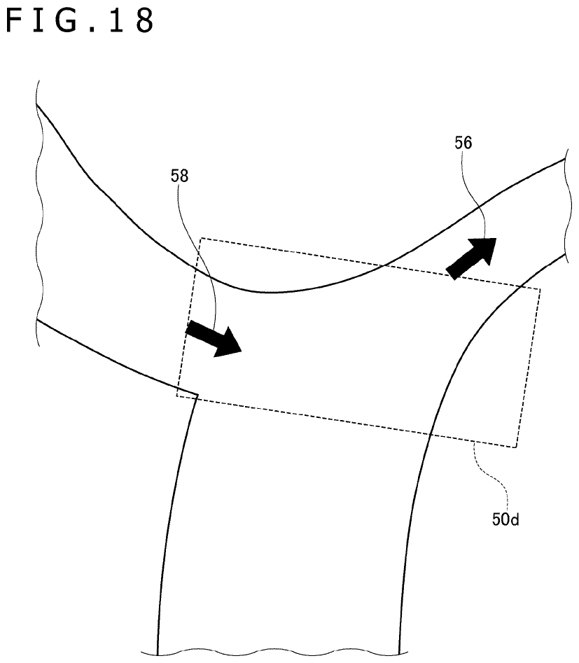

FIG. 18 illustrates an example of wind parameters set for a partial space 50d. For an entrance and an exit of the partial space 50d, a wind parameter 56 representing a wind direction at the entrance of the partial space 50d, and a wind parameter 58 representing a wind direction at the exit of the partial space 50d are set, respectively. Incidentally, in FIG. 18, two-dimensional wind directions are indicated by the wind parameters 56 and 58 in the form of directions of arrows similarly to the above example. However, considering that the actual partial space 50d has a three-dimensional shape, three-dimensional wind directions may be expressed by the wind parameters 56 and 58.

While the wind parameters 52 and 54 of the partial space 50a illustrated in FIG. 15 are set for opposite faces of a cuboid, the wind parameters 56 and 58 of the partial space 50d are set for any faces of a cuboid. Note that the wind parameters may be set for internal portions of a cuboid as well as faces of a cuboid.

When the player character exists within the partial space 50d, the wind direction determination unit 230 determines the wind direction at the position of the player character within the partial space 50d on the basis of the wind parameters 56 and 58 in the partial space 50d. Specifically, the wind direction determination unit 230 has a function of calculating a wind direction interpolated at any position between the entrance and the exit of the partial space 50d on the basis of the wind directions indicated by the wind parameters 56 and 58. The wind direction determination unit 230 having acquired the position of the player character in the partial space 50d from the player character control unit 222 may determine the wind direction at the foregoing position by interpolation on the basis of the wind directions at the entrance and the exit in the partial space 50d.

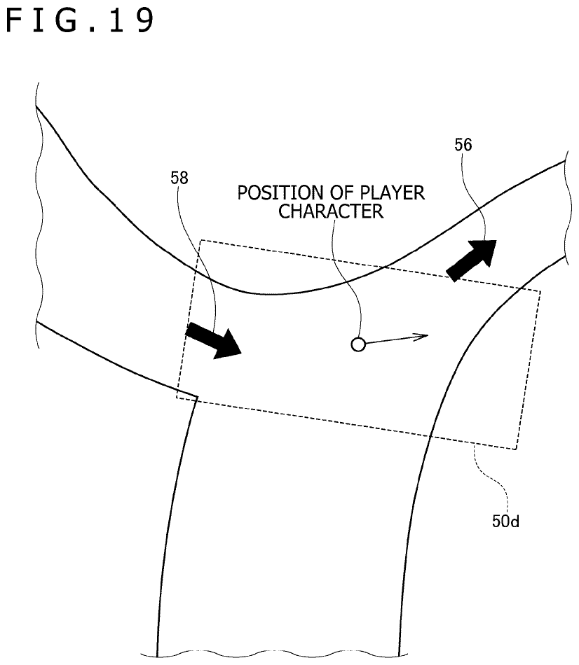

FIG. 19 illustrates the wind direction determined at the position of the player character.

During gameplay, the wind direction determination unit 230 constantly determination the wind direction at the position of the player character, and the control signal generation unit 234 generates control signals for individually driving each of at least the three fans 300 attached to the HMD 100 on the basis of the determined wind direction. The control signal generation unit 234 recognizes the arrangement of the plurality of fans 300 attached to the HMD 100. For example, in a case where the arrangement of the plurality of fans 300 is selectable from choices as illustrated in FIGS. 7 to 11, it is preferable that the user registers the selected arrangement of the fans 300 in the control signal generation unit 234 beforehand.

The control signal generation unit 234 calculates a relative angle formed by the visual line direction of the player character and the determined wind direction. The control signal generation unit 234 acquires the visual line direction of the player character from the player character control unit 222, and acquires the wind direction at the position of the player character from the wind direction determination unit 230. Note that the control signal generation unit 234 may acquire the visual line direction of the user from the orientation determination unit 228 as the visual line direction of the player character.

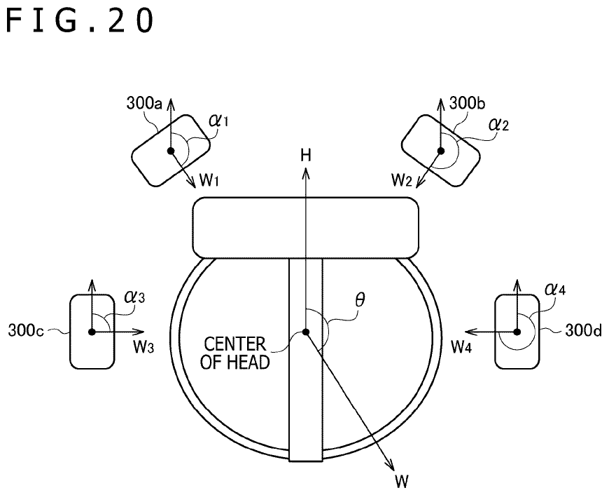

FIG. 20 illustrates a relative angle θ formed by a visual line direction H of the player character and a wind direction W. It is assumed herein that the fans 300a to 300d are arranged in such a manner as to form an angle α1 by the visual line direction H and the wind blowing direction of the fan 300a, an angle α2 by the visual line direction H and the wind blowing direction of the fan 300b, an angle α3 by the visual line direction H and the wind blowing direction of the fan 300c, and an angle α4 by the visual line direction H and the wind blowing direction of the fan 300d. Assuming herein that the airflow velocity is a predetermined airflow velocity |W|, the control signal generation unit 234 calculates an airflow velocity wₙ output from each of the fans 300 using following equation (2).

Wₙ−|\vec{W}|×cos (aₙ−θ) (2)

The control signal generation unit 234 having calculated the airflow velocity wₙ output from each of the fans 300 generates control signals for causing each of the fans 300 to output wind at the airflow velocity wₙ. In a case where the fans 300 are driven by pulse width modulation (PWM) control signals, for example, the control signal generation unit 234 may adjust pulse widths of the PWM control signals to control rotation speeds of the respective fans 300. Note that the control signal generation unit 234 may prohibit rotation of the fan 300 for which an airflow velocity wₙ lower than zero has been calculated as the airflow velocity wₙ on the basis of equation (2).

In addition, in the case of the airflow velocity wₙ<0, the control signal generation unit 234 may generate a control signal for causing reverse rotation of the corresponding fan 300. For example, when the control signal generation unit 234 generates a control signal for causing forward rotation of the fan 300c to supply wind to the head of the user from the left side, the control signal generation unit 234 may simultaneously generate a control signal for causing reverse rotation of the fan 300d. Particularly when the fans 300c and 300d are so disposed as to face each other with the head of the user interposed therebetween, the fans 300c and 300d are rotated in opposite directions to enable the user to clearly feel wind blowing in the left direction or the right direction with respect to the head.

The supply unit 240 transmits the control signals generated by the control signal generation unit 234 to the fan units 320 using the communication unit 202. According to the fan device 310 of the embodiment, the plurality of fan units 320 operate individually and independently. When the communication units 352 of the respective fan units 320 receive control signals addressed to themselves, the control units 350 drive the fans 300 according to the control signals. In this manner, the fan device 310 can rotate the plurality of fans 30 to supply wind indicating a correct direction to be followed by the player character. Accordingly, the user feeling this wind direction can estimate the correct direction followed by the player character. Note that the fan device 310 may have the control unit 350 configured to perform comprehensive control of the plurality of fans 300, instead of the fan units 320 each independently operating as described above.

In addition, discussed above has been the case where the airflow velocity |W| is a predetermined value. The wind parameter may include information indicating each wind intensity (airflow velocity) of at least two positions in the partial space 50. In this case, the airflow velocity determination unit 232 may have a function of calculating an airflow velocity interpolated between two positions in the partial space 50 on the basis of the information indicating airflow velocities set for these at least two positions. The airflow velocity determination unit 232 may determine the wind intensity (airflow velocity) at the position of the player character on the basis of a result of this interpolation.

In this case, as can be seen with reference to FIG. 17, the wind parameter 52 set for the entrance of the partial space 50a indicates the wind direction at the entrance and also the airflow velocity at the exit, while the wind parameter 54 set for the exit of the partial space 50a indicates the wind direction at the exit and also the airflow velocity at the exit. Generally, inside real caves, wind tends to blow at a low velocity in wide caves, while wind tends to blow at a high speed in narrow caves. Accordingly, when the wind parameters 52 and 54 include information associated with the airflow velocity, the user can feel a change of the cave shape. Specifically, when each of the vector WE as the wind parameter 52 and the vector WS as the wind parameter 54 has information indicating the airflow velocity (vector magnitude), the flow direction and the airflow velocity at the position of the player character can be determined using equation (1).

The present disclosure has been described above on the basis of the embodiment. The embodiment discussed above has been presented only by way of example. Accordingly, it should be understood by those skilled in the art that various modifications may be made for combinations of the respective constituent elements and the respective processes for processing, and that these modifications are also included in the scope of the present disclosure. While the fan device 310 includes a plurality of the independent fan units 320 in the embodiment described above, the fan device 310 may have a plurality of the integrated fan units 320.

While the airflow velocity determination unit 232 determines the airflow velocity according to the wind parameters set for the partial space 50 in the embodiment described above, the airflow velocity determination unit 232 in a modification may determine the airflow velocity according to a moving speed of the player character. For example, the airflow velocity determination unit 232 may determine a relatively high airflow velocity for a relatively high moving speed of the player character, and may determine a relatively low airflow velocity for a relatively low moving speed of the player character. Note that the airflow velocity determination unit 232 may determine the airflow velocity at the position of the player character considering both the wind parameters set for the partial space 50 and the moving speed of the player character.

In a modification, the control unit 350 may adjust an orientation of the fan 300 by using the orientation changing mechanism 354 such that the relative angle formed by the visual line direction of the user and the wind blowing direction of the fan 300 is equalized with the relative angle θ formed by the visual line direction H of the player character and the wind direction W. In a case where the orientation changing mechanism 354 is provided for all of the fan units 320 constituting the fan device 310, the control unit 350 can present an accurate wind direction to the user by adjusting each orientation of the fans 300 such that the angle θ can be formed by the visual line direction of the user (the front direction of the HMD) and the wind blowing direction of the fan 300. In this modification, the control signal generation unit 234 generates a control signal indicating the angle θ, and the control unit 350 adjusts the orientation of the fan 300 on the basis of this control signal.

In a modification, the control unit 350 may adjust the manner of blowing wind by changing spacing between the fan 300 and the user with use of the position changing mechanism 356. When wind is supplied from a position close to the user, the user feels the wind in a narrow range of the face. When wind is supplied from a position away from the user, the user feels the wind in a wide range of the face. Utilizing this difference in sensation, the control signal generation unit 234 may generate a control signal for decreasing the space between the fan 300 and the user by using the position changing mechanism 356 in a situation where it is desired to present the wind direction clearly. On the other hand, in a situation where it is desired to present the wind direction vaguely, the control signal generation unit 234 may generate a control signal for increasing the space between the fan 300 and the user using the position changing mechanism 356.

Air supplied by the fan 300 may be temperature-adjustable air. For example, when the fan 300 has a Peltier element or a heating wire, warm air can be supplied from the fan 300. This temperature adjustment of air can present to the user an environmental change in the virtual space.

The present disclosure may include the following aspects.

[Item 1] A fan device to be attached to a wearable device that is to be attached to a head of a user, the fan device including:
a first fan unit that has a fan for supplying wind to a front of a face of the user;
a second fan unit that has a fan for supplying wind to a left side of the face of the user; and
a third fan unit that has a fan for supplying wind to a right side of the face of the user.

[Item 2] The fan device according to Item 1, in which
the wearable device includes an attachment component that attaches the wearable device to the head of the user, and a housing that covers eyes of the user in a state where the wearable device is attached to the head of the user,
the first fan unit is to be attached to the housing, and
the second fan unit and the third fan unit are to be attached to the attachment component.

[Item 3] The fan device according to Item 1, in which at least one of the first fan unit, the second fan unit, and the third fan unit has a mechanism for changing an orientation of the fan.

[Item 4] The fan device according to Item 1, in which at least one of the first fan unit, the second fan unit, and the third fan unit has a mechanism for changing spacing between the fan and the user.

[Item 5] The fan device according to Item 1, in which
the fan of the first fan unit primarily supplies wind to a left front side of the face of the user, and
the fan device further includes a fourth fan unit that has a fan for primarily supplying wind to a right front side of the face of the user.

[Item 6] A wearable device to be attached to a head of a user, the wearable device including:
a first fan unit that has a fan for supplying wind to a front of a face of the user;
a second fan unit that has a fan for supplying wind to a left side of the face of the user; and
a third fan unit that has a fan for supplying wind to a right side of the face of the user.

[Item 7] A recording medium recording a program to be executed by a computer of an information processing device, the program causing the computer to implement:
a function of controlling a movement of a player character according to operation input from a user;
a function of determining a wind direction at a position of the player character within a virtual space;
a function of generating control signals for individually driving each of at least three fans attached to a wearable device based on the determined wind direction; and
a function of transmitting the control signals.

[Item 8] The recording medium according to Item 7, in which the function of determining a wind direction includes a function of determining a wind direction at a position of the player character based on information indicating wind directions set at at least two positions in the virtual space.

[Item 9] The recording medium according to Item 8, in which the function of determining a wind direction includes a function of determining a wind direction at a position of the player character by calculating a wind direction interpolated between wind directions set at at least two positions in the virtual space based on information indicating the wind directions at the at least two positions.

[Item 10] The recording medium according to Item 8, in which the information indicating the wind directions are set for an entrance and an exit of the virtual space.

[Item 11] The recording medium according to Item 7, in which the program causes the computer to implement a function of determining wind intensity at a position of the player character within the virtual space.

[Item 12] The recording medium according to Item 11, in which the function of generating the control signals includes a function of generating control signals for individually driving each of the at least three fans based on the determined wind intensity.

[Item 13] The recording medium according to Item 7, in which the function of generating the control signals includes a function of generating control signals for individually driving each of a first fan for supplying wind to a front of a face of the user, a second fan for supplying wind to a left side of the face of the user, and a third fan for supplying wind to a right side of the face of the user.

[Item 14] The recording medium according to Item 13, in which the function of generating the control signals includes a function of simultaneously generating a control signal for causing reverse rotation of the third fan and a control signal for causing forward rotation of the second fan.

The present disclosure is applicable to technical fields associated with supply of wind to a user wearing a wearable device on his/her head.

What is claimed is:

1. A fan device comprising:
a first fan coupled to the fan device at a first position and configured to supply airflow in a first direction;
a second fan coupled to the fan device at a second position and configured to supply airflow in a second direction; and
a third fan coupled to the fan device at a third position and configured to supply airflow in a third direction, wherein the first position is between the second position and the third position, and wherein the first direction is between the second direction and the third direction.

2. The fan device according to claim 1, wherein the second and third fans are configured to be attached to an attachment component of a wearable device.

3. The fan device according to claim 1, wherein the first fan is configured to be attached to a housing of a wearable device, and
wherein when the wearable device is worn on a head of a wearer, the housing is configured to cover eyes of the wearer.

4. The fan device according to claim 1, wherein at least one of the first fan, the second fan, or the third fan includes a mechanism configured to change an orientation of the corresponding fan.

5. The fan device according to claim 1, wherein at least one of the first fan, the second fan, or the third fan includes a mechanism configured to change a position of the corresponding fan with respect to the fan device.

6. The fan device according to claim 1, further comprising:
a fourth fan configured to primarily supply airflow in a fourth direction between the first fan and the second fan.

7. A wearable device configured to be worn on a head of a wearer, the wearable device comprising:
a first fan configured to supply airflow in a first direction aligned with a front of a face of the wearer;
a second fan configured to supply airflow in a first direction aligned with a left side of the face of the wearer; and
a third fan configured to supply airflow in a first direction aligned with a right side of the face of the wearer.

8. The wearable device of claim 7, further comprising:
a housing configured to cover eyes on the face in a state where the wearable device is attached to a head,
wherein the first fan is configured to be attached to the housing.

9. The wearable device of claim 7, further comprising:
an attachment component configured to attach the wearable device to a head,
wherein the second and third fans are configured to be attached to the attachment component.

10. The wearable device of claim 7, further comprising:
one or more processors;
memory storing instructions that, upon execution, cause the one or more processors to perform operations comprising:
controlling a movement of a player character according to operation input;
determining an airflow direction at a position of the player character within a virtual space;
generating at least a control signal driving a respective fan of the first fan, the second fan or the third fan based on the determined airflow direction; and
transmitting the control signal to the respective fan.

11. The wearable device of claim 10, wherein the determining the airflow direction includes determining the airflow direction at a position of the player character based on information indicating airflow directions set at least two positions in the virtual space.

12. The wearable device of claim 10, wherein the determining the airflow direction includes determining the airflow direction at a position of the player character by calculating the airflow direction interpolated between airflow directions set at least two positions in the virtual space based on information indicating the airflow directions at the at least two positions.

13. A non-transitory computer-readable medium storing instructions that, when executed by a computer cause the computer to perform operations comprising:
controlling a movement of a player character according to operation input;
determining an airflow direction at a position of the player character within a virtual space;
generating at least a control signal indicative of driving a respective fan of a first fan, a second fan or a third fan based on the determined airflow direction; and
transmitting the control signal.

14. The non-transitory computer-readable medium according to claim 13, wherein the determining the airflow direction includes determining an airflow direction at a position of the player character based on information indicating airflow directions set at least two positions in the virtual space.

15. The non-transitory computer-readable medium according to claim 13, wherein the determining an airflow direction includes determining an airflow direction at a position of the player character by calculating an airflow direction interpolated between airflow directions set at least two positions in the virtual space based on information indicating the airflow directions at the at least two positions.

16. The non-transitory computer-readable medium according to claim 15, wherein the information indicating the airflow directions are based on an entrance and an exit of the virtual space.

17. The non-transitory computer-readable medium according to claim 13, wherein the operations further comprise determining airflow intensity at a position of the player character within the virtual space.

18. The non-transitory computer-readable medium according to claim 17, wherein the generating the control signal includes generating the control signal based on the determined airflow intensity.

19. The non-transitory computer-readable medium according to claim 13, wherein the first fan is configured to supply airflow to a front of a face, the second fan is configured to supply airflow to a left side of the face; and the third fan is configured to supply airflow to a right side of the face.

20. The non-transitory computer-readable medium according to claim 19, wherein the generating the control signal includes simultaneously generating a control signal for causing reverse rotation of the third fan and a control signal for causing forward rotation of the second fan.
